(19) United States
(12) Patent Application Publication
(10) Pub. No.: US 2009/0228424 A1
(43) Pub. Date: Sep. 10, 2009

(54) PROGRAM RECOMMENDING APPARATUS AND PROGRAM RECOMMENDING METHOD

(75) Inventors: Kouichirou Mori, Saitama-shi (JP); Tomoko Murakami, Yokohama-shi (JP); Ryohei Orihara, Tokyo (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/399,149

(22) Filed: Mar. 6, 2009

(30) Foreign Application Priority Data
Mar. 6, 2008 (JP) 2008-056540

(51) Int. Cl. G06N 5/02; G06F 15/18

(52) U.S. Cl. 706/54; 706/12

(57) ABSTRACT

An apparatus includes: a module configured to extract category information and program abstracts of programs contained in an electronic program guide, extract program-specific terms from the program abstracts by morphological analysis and combine the category information and the program-specific terms to generate category-added terms; a module configured to analyze a history of programs viewed by a user based on the generated category-added terms to generate a preference vector indicating user's preferences for programs; a module analyzing the program abstracts based on the category-added terms to generate broadcast program vectors; a module generating a relevant term model for the category-added terms; a module calculating similarities between the preference vector and each of the broadcast program vectors based on the generated relevant term model; and a module outputting programs having the calculated similarities satisfying a predetermined condition as recommended programs matching with the user's preferences.

### RELATED APPLICATION(S)

The present disclosure relates to the subject matters contained in Japanese Patent Application No. 2008-056540 filed on Mar. 3, 2008, which are incorporated herein by reference in its entirety.

### FIELD

The present invention relates to a program recommending apparatus and a program recommending method for recommending TV programs to a user.

### BACKGROUND

It has become more difficult for a user to search for favorite programs because the number of programs has increased in recent years. In consideration of such a situation, there is an increasing need for a program recommending system. The system learns a user's preference from a history of programs viewed by the user and recommends user's favorite programs.

Program information has been digitized as an electronic program guide (EPG). There has been proposed a system which recommends programs by use of textual information such as categories, performers and program abstracts contained in the EPG. The system generally separates program abstracts into terms by morphological analysis, counts the terms and learns user's favorite terms. An example of such technique is disclosed in JP-B2-3351058. In this technique, the terms which appeared more frequently in programs viewed by the user are determined to be terms more preferred by the user. Accordingly, there is implemented a method of recommending programs containing a larger number of terms matching with the user's preferences.

On the other hand, there is generally used a method based on a vector space model in which user's preferences and program data are expressed in vectors with weighting values of terms as elements. An example of such method is disclosed in JP-A-2007-202181. For example, the appearance frequency of a term in programs is used as the weighting value of the term. In the vector space model, similarity between a user's preference vector and a program vector is defined by an inner product or a cosine similarity. There is implemented a method of recommending programs with high similarity to the user's preference vector.

In the aforementioned vector space model, there was a defect that relevant terms or synonymous terms could not be considered. When, for example, a program frequently containing a term “Conjuring Trick” is viewed, the weighting value of the term “Conjuring Trick” becomes high but the weighting value of a term “Magic” or “Magician A (person's name)” regarded as a term relevant to the term “Conjuring Trick” does not become high.

In order to solve this problem, there has been proposed a method called latent semantic analysis (LSA) or latent semantic indexing (LSI). An example of a technique employing such method is disclosed in JP-A-2006-048287 or in the document listed below. When LSA is used, a matrix expressing relevant terms (hereinafter referred to “relevant term model”) can be generated from an index term-program matrix generated from EPG data. When the relevant term model is used, terms frequently collocating in one and the same program are regarded as relevant terms so that the terms can be reduced to a new term. When vectors are dimensionally reduced by the relevant term model, similarity between a preference vector and each program vector can be calculated in consideration of relevant terms.

S. Deerwester, S. T. Dumais, G. W. Furnas, T. K. Landauer and R. Harshman, Indexing by Latent Semantic Analysis, Journal of the American Society for Information Science, Vol. 41, pp. 391-407, 1990

In the techniques described above, there were however the following problems.

The first problem is that the weighting values of terms having low ability to specify programs become high because frequencies of general terms appearing in a large number of programs are apt to be high. For example, a term “News” or “Information” will be frequently contained in programs viewed by the user because the term is contained in lots of programs. For this reason, the weighting value of “News” or “Information” becomes high so that “News” or “Information” is regarded as a term more matching with user's preferences. Although programs containing the term “News” or “Information” are recommended, it is difficult to specify recommendation program because the term is contained in lots of programs. Recommending all programs containing the term “News” or “Information” causes low recommendation accuracy.

The second problem is that context having terms appearing therein is not taken into consideration at all in the background art method. When, for example, the user views Korean dramas frequently, the weighting value of a term “Korea” becomes high because the term “Korea” is frequently contained in the Program abstract field. For this reason, Korean dramas are recommended frequently but news programs concerned with election of Korean President are also recommended at the same time.

Consider a user frequently viewing English conversation programs as another example. Since “English” is frequently contained in the Program abstract field of English conversation programs, the weighting value of the term “English” becomes high. For this reason, programs containing the term “English” are recommended frequently. However, a preschool education program, a high school education program and a language variety show program differ widely even when each of the programs contains the term “English”. That is, in television programs, program content vary widely in accordance with the contextual meaning of the term even when the same term is used. There arises a problem that contexts cannot be discriminated when the term is used directly.

The third problem, which is related to the aforementioned problem, is that an accurate relevant term model used in latent semantic analysis cannot be generated by a method using a term directly without consideration of the contextual meaning of the term. For example, consider that a relevant term model is generated from abstracts of the following two programs (a) and (b). The program (a) is an animation program whereas the program (b) is a tour variety show program.

Abstract for Program (a): An adventure fantasy for starting a tour in search of seven jewels for rescuing a kingdom under control of an evil king.

Abstract for Program (b) : A winter tour in Akita for soaking in an open-air bath for snow-scene viewing, for fully enjoying a hot-pan meal and for introducing hotels for mature adults to stay comfortably.

The relevant term model is generated based on collocation of terms appearing in program abstracts. Accordingly, terms frequently collocating in a large number of programs are determined to be more relevant to one another but terms rarely collocating in a large number of programs are determined to be less relevant to one another. The terms determined to be relevant to “Tour” based on the two programs are “King”, “Control”, “Kingdom”, “Adventure”, “Fantasy”, “Winter”, “Akita”, “Open-Air Bath”, “Hotel”, etc. Although it is apparent that the terms relevant to “Tour” in the animation program are different from the terms relevant to “Tour” in the tour variety show program, these relevant terms cannot be discriminated by a method using the term “Tour” directly.

### SUMMARY

According to a first aspect of the present invention, there is provided a program recommending apparatus including: an electronic program guide receiving module configured to receive an electronic program guide transmitted from a broadcast station; a category-added term generating module configured to extract category information and program abstracts of programs contained in the electronic program guide, extract program-specific terms from the program abstracts by morphological analysis and combine the category information and the program-specific terms to generate category-added terms; a history storage module configured to store a history of programs viewed by a user; a preference vector generating module configured to analyze the history based on the generated category-added terms to generate a preference vector indicating user's preferences for programs; a broadcast program vector generating module configured to analyze the program abstracts of the programs contained in the electronic program guide based on the category-added terms to generate broadcast program vectors indicating the program abstracts of the programs respectively; a relevant term model generating module configured to generate a relevant term model for the category-added terms; a program similarity calculating module configured to calculate similarities between the preference vector and each of the broadcast program vectors based on the generated relevant term model; and a program recommending module configured to output programs having the calculated similarities satisfying a predetermined condition as recommended programs matching with the user's preferences.

According to a second aspect of the present invention, there is provided a program recommending method including: receiving an electronic program guide transmitted from any broadcast station; extracting category information and program abstracts of programs contained in the received electronic program guide; extracting program-specific terms from the program abstracts by morphological analysis; combining the category information and the program-specific terms to thereby generate category-added terms; storing a history of programs viewed by a user; analyzing the history based on the generated category-added terms to thereby generate a preference vector indicating user's preferences for programs; analyzing the program abstracts of the programs contained in the electronic program guide based on the category-added terms to thereby generate broadcast program vectors indicating the program abstracts of the programs respectively; generating a relevant term model for the category-added terms; calculating similarities between the preference vector and each of the broadcast program vectors based on the generated relevant term model; and outputting programs having the calculated similarities satisfying a predetermined condition as recommended programs matching with the user's preferences.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 is a block diagram showing an example of an overall configuration of a program recommending apparatus according to an embodiment of the invention.

FIG. 2 is a flowchart showing a specific example of overall processing in the program recommending apparatus.

FIG. 3 is a flowchart showing a specific example of a category-added term generating process in a category-added term generating module.

FIG. 4 is a view showing a specific example of program information contained in an electronic program guide.

FIG. 5 is a flowchart showing a specific example of a relevant term model generating process in a relevant term model generating module.

FIG. 6 is a view showing a specific example of an index term-program matrix generated from the electronic program guide.

FIG. 7 is a view for specifically explaining singular value decomposition and dimensional reduction of the index term-program matrix.

FIG. 8 is a view showing a specific example of the index term-program matrix after dimensional reduction.

FIG. 9 is a flowchart showing a specific example of a preference vector generating process in a preference vector generating module.

FIG. 10 is a view showing a specific example of a preference vector.

FIG. 11 is a flowchart showing a specific example of a similarity calculating process in a program similarity calculating module.

FIG. 12 is a view showing a specific example of a preference vector and broadcast program vectors.

FIG. 13 is a view showing vectors obtained by normalizing the preference vector and the broadcast program vectors shown in FIG. 12.

FIG. 14 is a view showing a calculation example of similarity between the preference vector and each broadcast program vector by use of an inner product.

### DETAILED DESCRIPTION OF THE EMBODIMENTS

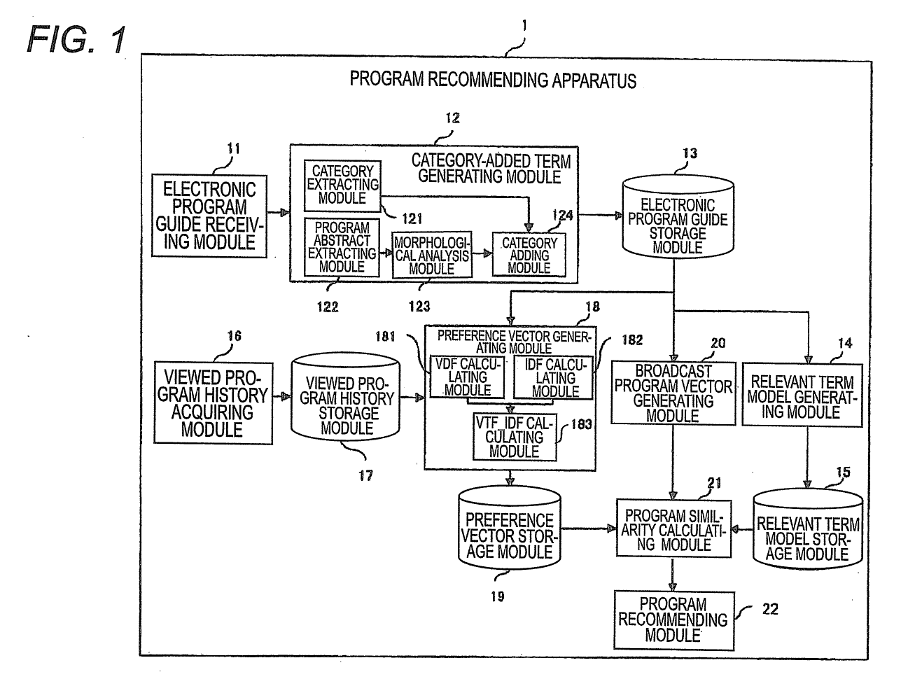

Embodiments of the invention will be described below with reference to the drawings. FIG. 1 is a block diagram showing an example of overall configuration of a program recommending apparatus 1 according to an embodiment of the invention.

The program recommending apparatus 1 is roughly defined by four blocks. The first block, which is related to generation of category-added terms, includes an electronic program guide receiving module 11, a category-added term generating module 12, and an electronic program guide storage module 13. The second block, which is related to generation of a relevant term model indicating relevance ratios between terms, includes a relevant term model generating module 14, and a relevant term model storage module 15. The third block, which is related to generation of a preference vector indicating user's preferences, includes a viewed program history acquiring module 16, a viewed program history storage module 17, a preference vector generating module 18, and a preference vector storage module 19. The fourth block, which is related to recommendation of programs, includes a broadcast program vector generating module 20, a program similarity calculating module 21, and a program recommending module 22.

The electronic program guide receiving module 11 receives an electronic program guide (EPG) transmitted as textual information from television stations.

The category-added term generating module 12 includes a category extracting module 121, a program abstract extracting module 122, a morphological analysis module 123, and a category adding module 124. The category extracting module 121 extracts category texts from the electronic program guide. The program abstract extracting module 122 extracts program abstract parts from the respective pieces of program information in the electronic program guide. The morphological analysis module 123 separates each of the program abstract into terms by morphological analysis. The category adding module 124 adds a category to each of the terms separated by the morphological analysis.

The category-added term generating module 12 stores the electronic program guide in the electronic program guide storage module 13 in the condition that the category-added terms are associated with each program abstract part. The category-added term generating module 12 generates category-added terms by combining terms appearing in a program with the category of the program, and replaces the original terms with the generated category-added terms. When, for example, a term “Korea” appears in a program belonging to an “Overseas Drama” category, “Korea” is replaced with “Overseas Drama—Korea”. When, for example, a term “Korea” appears in a program belonging to an “Overseas/International” category, “Korea” is replaced with “Overseas/International—Korea”. Thus, the terms “Overseas Drama—Korea” and “Overseas/International—Korea” are regarded as two different terms.

Categories in the electronic program guide are defined by the ARIB standard in Japan. For example, as the categories, there are provided main categories of “News”, “Sports”, “Information/Variety Show”, “Drama” and “Documentary/Education” and sub categories of “Politics and National Diet”, “Economy and Market”, “Baseball”, “Soccer”, “Entertainment and Variety Show”, “Health and Medical Care”, “Domestic Drama”, “Overseas Drama” and “History and Tour” under the main categories. This embodiment is based on the assumption that about 100 sub categories are used.

The relevant term model generating module 14 generates a relevant term model by singular value decomposition and dimensional reduction of an index term-program matrix generated by using category-added terms contained in programs in a certain predetermined period as index terms in latent semantic analysis, and stores the generated relevant term model in the relevant term model storage module 15.

The latent semantic analysis is a method often used in the field of information retrieval and a technique for improving retrieval accuracy by projecting a document vector in a high dimensional space onto a low dimensional space. In the invention, this latent semantic analysis is used for improvement of recommendation accuracy in such a manner that the latent semantic analysis is applied to a preference vector and a broadcast program vector which will be described later.

The viewed program history acquiring module 16 acquires a viewed program history in a desired period from the viewed program history storage module 17 which stores a history (log) of programs viewed by the user.

The preference vector generating module 18 includes a VTF (Viewed Term Frequency) calculating module 181, an IDF (Inverse Document Frequency) calculating module 182, and a VTF_IDF calculating module 183. The VTF calculating module 181 counts terms appearing in programs viewed by the user in a certain predetermined period and calculates VTFs indicating appearance frequencies of the terms respectively. The IDF calculating module 182 calculates IDFs indicating singularities of the terms respectively. The VTF_IDF calculating module 183 calculates VTF_IDFs from the VTFs and the IDFs. The VTF_IDF is an index for weighting a term in such a manner that the term is determined to be a more significant term indicating user's preference when the term is a singular term which is more frequently contained in programs viewed by the user and which appears in specific programs more frequently. The VTF_IDF calculating module 183 further generates a preference vector indicating user's preferences based on the VTF_IDFs and stores the preference vector in the preference vector storage module 19.

The broadcast program vector generating module 20 reads program information of broadcast programs, generates a broadcast program vector indicating contents of programs based on the program information and outputs the generated broadcast program vector to the program similarity calculating module 21.

The program similarity calculating module 21 calculates similarity between the preference vector generated by the preference vector generating module 18 and the broadcast program vector generated by the broadcast program vector generating module 20.

The program recommending module 22 determines whether the similarity between the preference vector and the broadcast program vector calculated by the program similarity calculating module 21 is larger than a predetermined threshold or not, and outputs programs having similarity larger than the threshold as recommended programs.

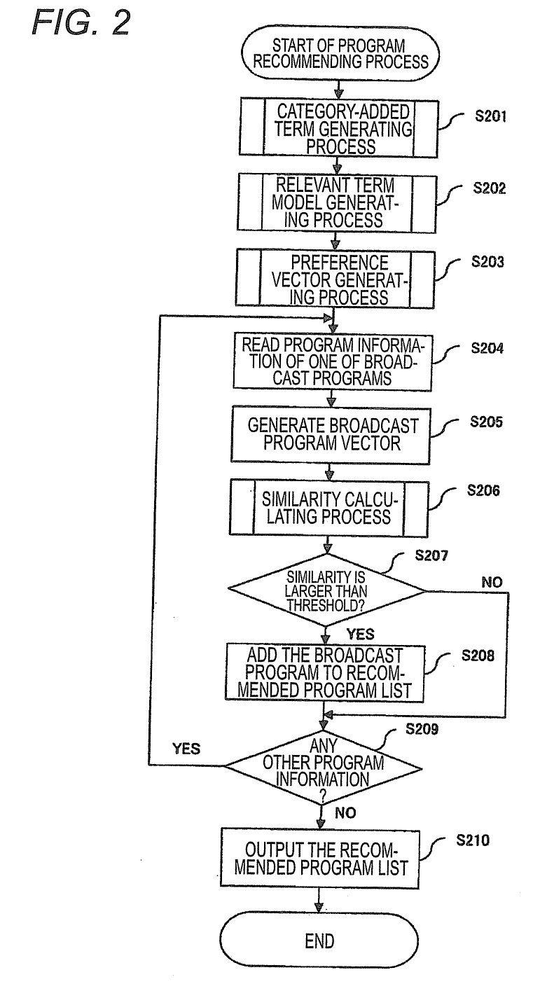

FIG. 2 is a flowchart showing a specific example of overall processing of the program recommending apparatus 1.

In step S201, the category-added term generating module 12 generates category-added terms indicating contents of respective programs in an electronic program guide and stores the electronic program guide, inclusive of the category-added terms, in the electronic program guide storage module 13.

In step S202, the relevant term model generating module 14 generates a relevant term model by using programs in a certain predetermined period in the electronic program guide storage module 13 and stores the generated relevant term model in the relevant term model storage module 15.

In step S203, the preference vector generating module 18 generates a preference vector indicating user's preferences by using a viewed program history stored in the viewed program history storage module 17 and information of the electronic program guide stored in the electronic program guide storage module 13, and stores the generated preference vector in the preference vector storage module 19.

In step S204, the broadcast program vector generating module 20 reads program information from the electronic program guide.

In step S205, the broadcast program vector generating module 20 generates a broadcast program vector based on the program information. Specifically, the broadcast program vector generating module 20 generates a broadcast program vector by counting the appearance frequency of each category-added term in the program abstract field.

In step S206, the program similarity calculating module 21 calculates similarity between the preference vector indicating user's preferences and the broadcast program vector.

In step S207, the program recommending module 22 determines whether the similarity between the preference vector and the broadcast program vector is larger than a predetermined threshold or not. When the similarity is larger than the threshold, the program recommending module 22 determines the broadcast program to be a program matching with the user's preferences. Then, the routine of processing proceeds to step S208. On the contrary, when the similarity is smaller than the threshold, the program recommending module 22 determines the broadcast program to be a program not matching with the user's preferences. Then, the routine of processing proceeds to step S209.

In the step S208, the program recommending module 22 adds the program matching with the user's preferences to a recommended program list.

In the step S209, the broadcast program vector generating module 20 determines whether there is any other broadcast program to be determined. When there is still another broadcast program, the routine of processing goes back to the step S204. Processing in the steps S204 to S208 is repeated unless there is no other broadcast program. On the contrary, when there is no other broadcast program, the routine of processing proceeds to step S210.

In the step S210, the program recommending module 22 outputs the generated recommended program list to a display device (not shown). Then, the processing is terminated.

Processing methods of category-added term generation (the step S201), relevant term model generation (the step S202), preference vector generation (the step S203) and similarity calculation (the step S206) in FIG. 2 will be described below in detail.

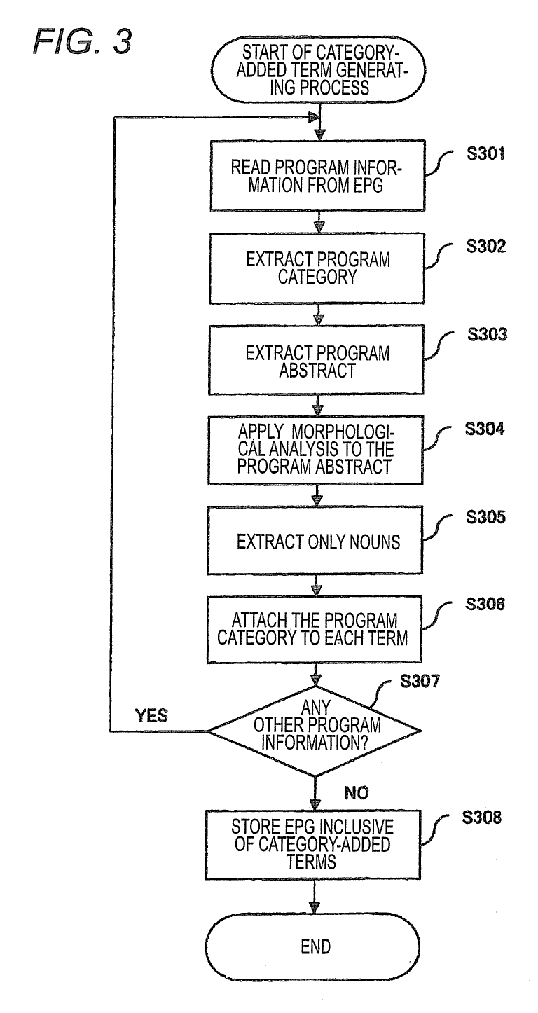

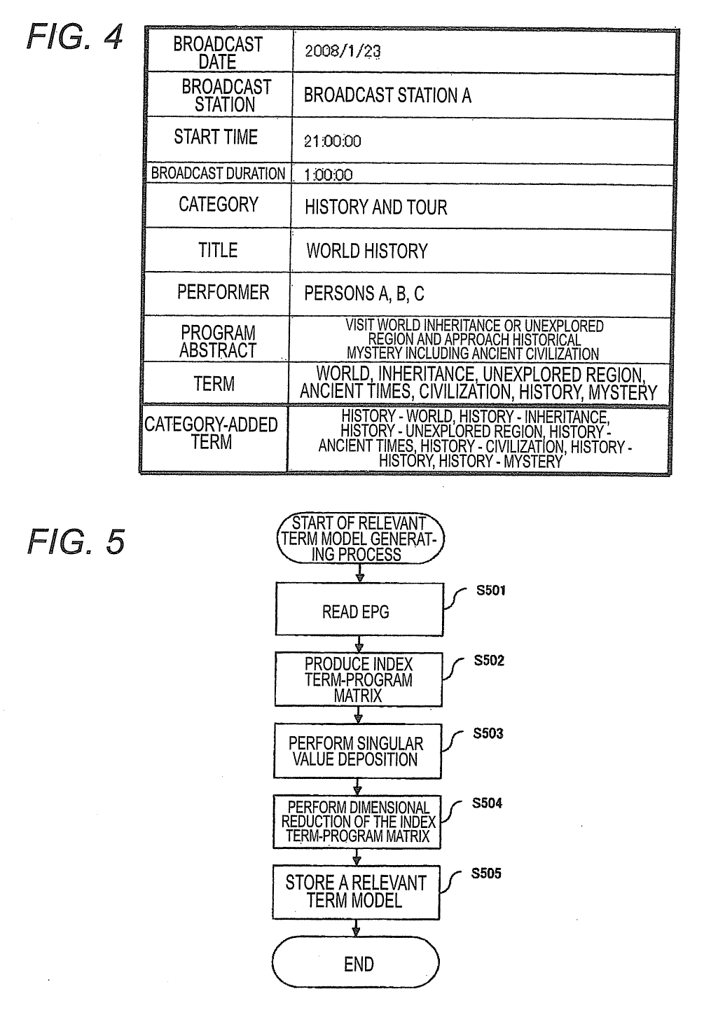

FIG. 3 is a flowchart showing a specific example of the category-added term generating process (the step S201) in the category-added term generating module 12. FIG. 4 is a view showing a specific example of program information contained in an electronic program guide.

In step S301, the category-added term generating module 12 acquires an electronic program guide (EPG) from the electronic program guide receiving module 11 and reads program information from the electronic program guide. The program information shown in FIG. 4 includes fields of “Broadcast Date”, “Broadcast Station”, “Start Time”, “Broadcast Duration”, “Category”, “Title”, “Performer” and “Program abstract”. Categories include main categories, and sub categories into which the main categories are further categorized finely. This embodiment is based on the assumption that the subcategories are used.

In step S302, the category-added term generating module 12 extracts a program category from the read program information. The program category in the program information in FIG. 4 is “History and Tour”. Incidentally, when two or more categories are attached to a program, all the categories may be extracted or only the first category may be extracted.

In step S303, the category-added term generating module 12 extracts program abstract from the program information.

In step S304, the category-added term generating module 12 applies morphological analysis to the extracted program abstract. The program abstract is separated into terms by morphological analysis. At the same time, respective parts of speech of the terms are clarified by the morphological analysis.

In step S305, the category-added term generating module 12 extracts only nouns from the group of terms separated by the morphological analysis. This is because the significant term (program-specific term) for specifying the program abstract is often a noun. The nouns extracted in this process are “World”, “Inheritance”, “Unexplored Region”, “Ancient Times”, “Civilization”, “History” and “Mystery” in the “Term” field. Incidentally, demonstrative pronouns such as “This” and “That” and nouns having no contents such as “Fact” and “Thing” can be removed from the nouns by use of a stop word list.

In step S306, the category-added term generating module 12 generates category-added terms by attaching the program category to the extracted terms respectively. Incidentally, it is preferable that the category is coded in advance. In the example shown in FIG. 4, the “History and Tour” is coded as “History” so that “History” is attached to each term. When categories are attached to one program, the category-added term generating module 12 may generate category-added terms as all combinations of the categories and the terms or may use only the first category. Hereinafter, all processes will be performed based on the category-added terms.

In step S307, the category-added term generating module 12 determines whether any other program information is contained in the electronic program guide (EPG) or not. When decision is made that any other program information is contained, the routine of processing goes back to the step S301. Processing in the steps S301 to S307 is repeated unless processing for all the programs is completed. On the contrary, when decision is made that there is no other program information, the routine of processing proceeds to step S308.

In the step S308, the category-added term generating module 12 stores the electronic program guide, inclusive of the generated category-added terms, in the electronic program guide storage module 13. Then, the routine of processing is terminated.

As described above, use of not simple terms but category-added terms has several advantages. Firstly, the term's ability to specify programs is improved so that user's preferences can be obtained more accurately, and that improvement in recommendation accuracy can be expected. Here, “term's ability to specify programs” expresses the ability to reduce the number of programs specified by a term when the term is found to be the user's favorite.

For example, assume that a term “News” is frequently contained in programs viewed by the user and is found to be the user's favorite. The term “News” is however a term which appears in a large number of programs that the term “News” cannot reduce the number of user's favorite programs. That is, the term “News” is low in ability to specify programs. Although a method of recommending all programs containing the term “News” without reduction in number of programs may be considered, this method causes remarkable lowering of recommendation accuracy because most of the programs are programs not matching with the user's preferences.

On the other hand, when category-added terms are used, a term “News” is separated into “Politics and National Diet—News”, “Economy and Market—News”, “Baseball—News”, “Soccer—News” and “Horse Racing—News” so that user's detailed preferences which could not be found from only the term “News” can be specified to make it easy to reduce the number of programs.

Secondly, the category can be used as context information to make it easy to specify the meaning of each term in connection with the term's ability to specify programs. As in the aforementioned example, when Korean dramas were frequently viewed by the user, weighting of a term “Korea” becomes high because the term “Korea” is frequently contained in the Program abstract field. Although Korean dramas can be hence recommended frequently, news programs concerned with election of Korean President may be also recommended. On the other hand, when category-added terms are used, the term “Korea” is separated into “Overseas/International—Korea” and “Overseas Drama—Korea” so that whether the user's favorite is Korean dramas or news related to Korea can be specified accurately.

Consider a user frequently viewing English conversation programs as another example. Since a term “English” is frequently contained in the Program abstract field of English conversation programs, the weighting value of the term “English” becomes high. For this reason, programs containing the term “English” are recommended frequently. However, a preschool education program, a high school education program and a language variety show program differ widely in program contents even when each of the programs contains the term “English”. When category-added terms are used in such a case, the term “English” can be separated into “Preschool and Primary School—English”, “High School—English”, “Conversation and Language—English” and “Talk Variety—English” to make it easy to specify the type of the English program attracting user's interest.

FIG. 5 is a flowchart showing a specific example of the relevant term model generating process (step S202) in the relevant term model generating module 14.

In step S501, the relevant term model generating module 14 reads an electronic program guide (EPG) from the electronic program guide storage module 13.

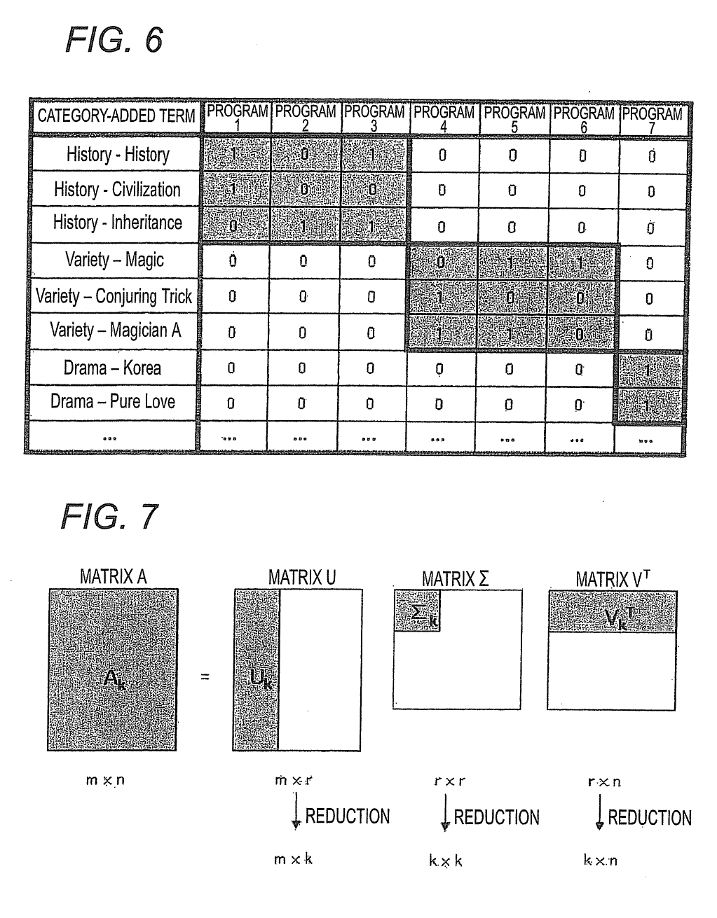

In step S502, the relevant term model generating module 14 generates an index term-program matrix from the electronic program guide so that latent semantic analysis can be applied to the index term-program matrix. FIG. 6 is a view showing a specific example of the index term-program matrix generated from the electronic program guide. The index term-program matrix in FIG. 6 is formed so that rows indicating category-added terms and columns indicating programs are arranged. The value of a matrix element is set at “1” when the program contains the category-added term, whereas the value of a matrix element is set at “0” when the program does not contain the category-added term. Practically, the weighting value of each term such as TFIDF may be used in place of “0” or “1”. For example, Program 1 is a program containing terms “History—History” and “History—Civilization”. That is, Programs 1, 2 and 3 are “History” programs which are assumed to have similar contents. Programs 4, 5 and 6 are “Variety” programs which are assumed to have similar contents. Program 7 is a “Drama” program. Although the matrix shown here is a very small matrix as an example, the matrix may be practically such a huge matrix that has tens of thousands of terms and thousands of programs because the matrix is generated from all programs contained in the electronic program guide.

In step S503, the relevant term model generating module 14 performs singular value decomposition of the index term-program matrix. It is for the purpose of achievement of dimensional reduction of a high-dimensional vector by singular value decomposition in latent semantic analysis. An index term-program matrix A with m rows and n columns can be decomposed into three matrices U, Σ and V^{T} by singular value decomposition, as given by the following expression (1).

A=UΣV^{T} (1)

The matrix Σ is a matrix in which r-pieces of elements σ₁, σ₂, . . . , σᵣ (σ₁≧σ₂≧ . . . ≧σᵣ>0) are arranged diagonally while the remaining elements take “0” when rank (A) is equal to r. This σᵢ (1≦i≦r) is referred to as “singular value.”

In step S504, the relevant term model generating module 14 performs dimensional reduction of the index term-program matrix based on singular values. FIG. 7 is a view for specifically explaining singular value decomposition and dimensional reduction of an index term-program matrix. In FIG. 7, the matrix Σ is reduced from an r-by-r matrix to a k-by-k matrix based on k largest singular values selected from singular values of the matrix Σ, so that the k-by-k matrix is formed as a matrix Σₖ. The matrices U and V^{T} are reduced to an m-by-k matrix and a k-by-n matrix respectively in accordance with the matrix Σ, so that them-by-k matrix and the k-by-n matrix are formed as matrices Uₖ and Vₖ^{T} respectively. The reduced matrix Aₖ is calculated by the following expression (2) (A and Aₖ have the same size). Since the matrix Uₖ is a matrix in which relevant term information is stored, the matrix Uₖ is called “relevant term model” here.

Aₖ=UₖΣₖVₖ^{T} (2)

In step S505, the relevant term model generating module 14 stores the relevant term model obtained by dimensional reduction in the relevant term model storage module 15. Then, the process is terminated.

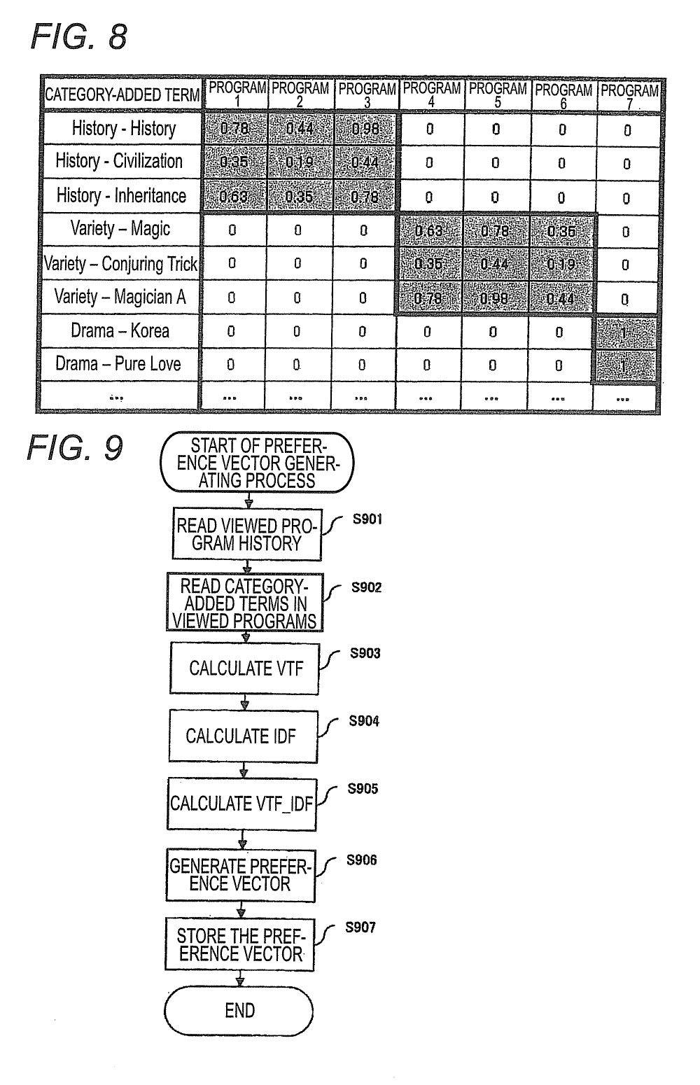

FIG. 8 is a view showing a specific example of the index term-program matrix after dimensional reduction. A matrix obtained by dimensional reduction of the matrix in FIG. 6 based on k=3 is shown in FIG. 8. Dimensional reduction has an advantage that relevant terms can be considered in calculation of similarities between program vectors. When, for example, similarity between Programs 1 and 2 in the original matrix A is calculated by the inner product of column vectors, the similarity is 0 because there is no term collocating in both Programs 1 and 2. On the other hand, when similarity between Programs 1 and 2 in a reduced matrix A₃ is calculated by the inner product of column vectors, the similarity is 0.63 so that Programs 1 and 2 are determined to be similar programs.

This difference lies in consideration of relevant terms in the reduced matrix A₃. As apparent from FIG. 6, “History—History”, “History—Civilization” and “History—Inheritance” are determined to be high relevance terms because “History—History” and “History—Civilization” collocate from Program 1 while “History—History” and “History—Inheritance” collocate from Program 3. For this reason, comparatively high weighting is given not only to “History—Inheritance”, but also to “History—History” and “History—Civilization” in the reduced matrix A₃ to thereby cause high similarity between Program 2 and Program 1 or 3 though Program 2 includes no term but “History—Inheritance”. When latent semantic analysis is performed thus, determination as for relevance among terms is automatically made based on terms collocating in programs so that there is an advantage that similarity between the programs can be obtained in consideration of relevant terms.

For example, consider that a relevant term model is generated from abstracts of the following two programs (a) and (b). The program (a) is an animation program whereas the program (b) is a tour variety show program.

Abstract for Program (a): An adventure fantasy for starting a tour in search of seven jewels for rescuing a kingdom under control of an evil king.

Abstract for Program (b) : A winter tour in Akita for soaking in an open-air bath for snow-scene viewing, for fully enjoying a hot-pan meal and for introducing hotels for mature adults to stay comfortably.

The relevant term model is generated based on collocation of terms appearing in program abstracts. Terms frequently collocating in a large number of programs are determined to be more relevant to one another but terms rarely collocating in a large number of programs are determined to be less relevant to one another. The terms determined to be relevant to “Tour” based on the two programs are “King”, “Control”, “Kingdom”, “Adventure”, “Fantasy”, “Winter”, “Akita”, “Open-Air Bath”, “Hotel”, etc.

Although it is apparent that the terms relevant to “Tour” in the animation program are different from the terms relevant to “Tour” in the tour variety show program, these relevant terms cannot be discriminated by a method using the term “Tour” directly. That is, relevant terms are collectively obtained because “Tour” in the animation program and “Tour” in the tour variety show program are handled equivalently.

However, an accurate relevant term model can be generated when category-added terms are used as index terms in latent semantic analysis. In the aforementioned case, the same terms “Tour” can be discriminated because the same terms “Tour” are replaced with category-added terms such as “Anime—Tour” for the animation program and “Tour—Tour” for the tour variety show program. Terms relevant to “Anime—Tour” are “Anime—Adventure”, “Anime—Fantasy”, etc. Terms relevant to “Tour—Tour” are “Tour—Open-Air Bath”, “Tour—Hotel”, etc. The two groups of terms relevant to “Anime—Tour” and “Tour—Tour” can be discriminated from each other accurately because the two groups are not mixed with each other.

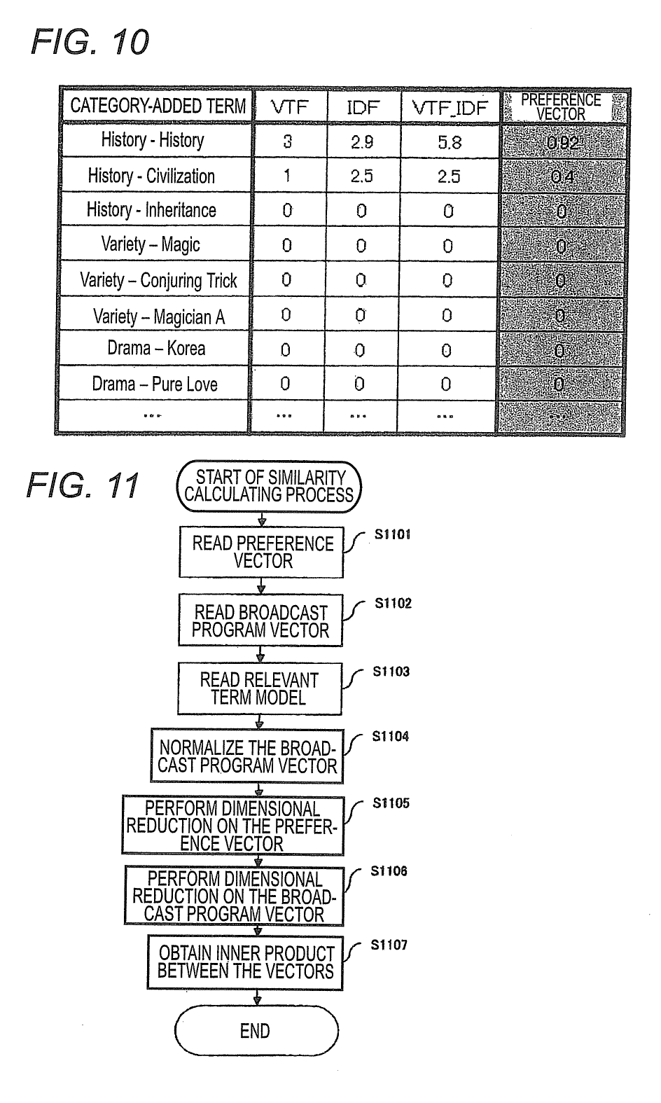

FIG. 9 is a flowchart showing a specific example of the preference vector generating process (the step S203) in the preference vector generating module 18. FIG. 10 is a view showing a specific example of each index value and a preference vector.

In step S901, the preference vector generating module 18 reads a history of programs viewed by the user. The viewed program history is provided as a list of program IDs or program titles viewed by the user.

In step S902, the preference vector generating module 18 acquires category-added terms contained in programs viewed by the user from the electronic program guide storage module 13.

In step S903, the preference vector generating module 18 calculates VTF indicating the appearance frequency of a category-added term k based on the history of programs viewed by the user in a past predetermined period T_{A}. The VTF shown in FIG. 10 means that “History—History” appeared three times and “History—Civilization” appeared once in the programs viewed by the user. The user in this example is assumed to prefer history programs. Incidentally, the period T_{A} may be set at any length, for example, the past week.

In step S904, the preference vector generating module 18 calculates IDF indicating singularity (ability to specify programs) of the category-added term k based on the electronic program guide in a certain predetermined period T_{B}. The IDF of the category-added term k is calculated by the following expression (3).

$$IDF ( k ) = {log}_{2} ( \frac{n}{n ( k )} ) \qquad ( 3 )$$

In the expression (3), n(k) is the number of programs containing the category-added term k in the period T_{B}, and n is the total number of programs in the period T_{B}.

The period T_{B} used in the calculation may be the same as the period T_{A} for obtaining VTF or may be completely different from the period T_{A}, that is, data in another period such as one week since now may be used for the calculation. The IDF may be calculated in advance because the IDF is calculated regardless of the history of programs viewed by the user.

In the expression (3), IDF(k) takes a low value when the category-added term k appears in a large number of programs and takes a high value when the category-added term k appears only in a small number of programs. That is, IDF(k) indicates the category-added term's ability to specify programs. In the example shown in FIG. 10, the IDF of “History—History” is 2.9 and the IDF of “History—Civilization” is 2.5. The IDF of a term having a VTF of 0 is regarded as 0 without necessity of calculation because the VTF_IDF of the term is definitely 0.

In step S905, the preference vector generating module 18 calculates VTF_IDF from the VTF and the IDF of the category-added term k. The VTF_IDF is calculated by the following expression (4).

VTF_IDF(k)=log₂(VTF(k)+1)·IDF(k) (4)

Incidentally, the reason why the logarithm of the VTF is taken is that the influence of the VTF is too strong if the value of the VTF is used directly. As shown in FIG. 10, the VTF_IDF of “History—History” is 5.8 and the VTF_IDF of “History—Civilization” is 2.5.

In step S906, the preference vector generating module 18 generates a preference vector normalized so that the norm of the VTF_IDF vector becomes 1. As shown in FIG. 10, the preference vector is obtained from a matrix which is formed so that category-added terms for specifying programs are arranged in rows while index values (VTF_IDF) obtained by analyzing program abstracts based on the category-added terms are arranged in a column.

In step S907, the preference vector generating module 18 stores the generated preference vector in the preference vector storage module 19. Then, the process is terminated.

FIG. 11 is a flowchart showing a specific example of the similarity calculating process (the step S206) in the program similarity calculating module 21.

In step S1101, the program similarity calculating module 21 reads a user's preference vector from the preference vector storage module 16.

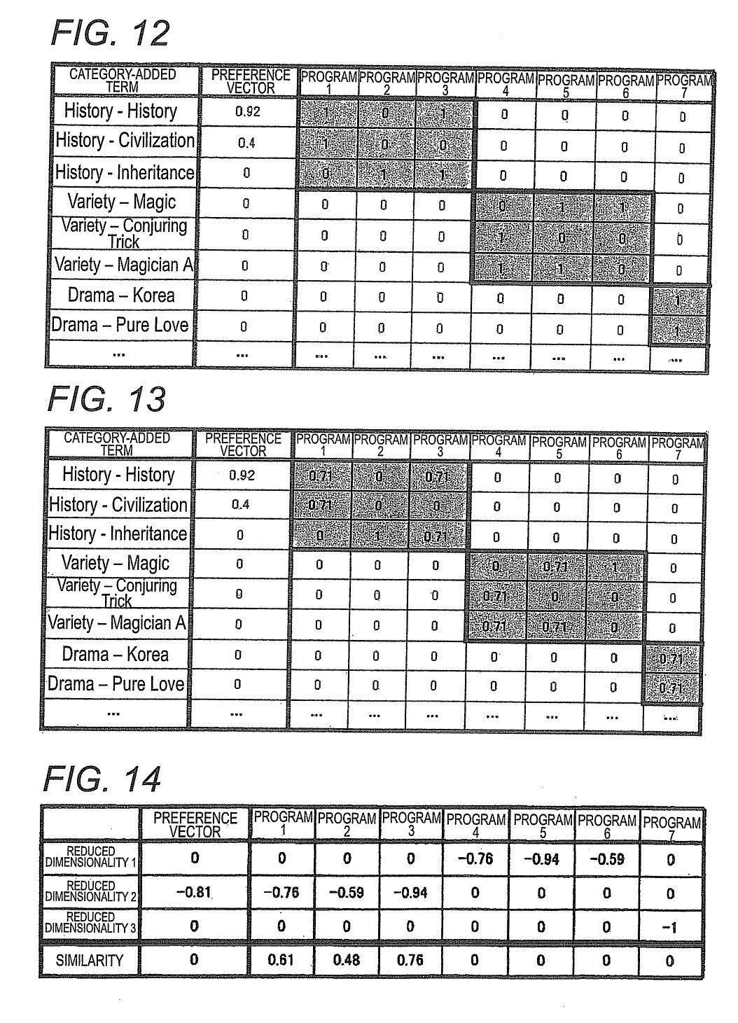

In step S1102, the program similarity calculating module 21 reads a broadcast program vector generated by the broadcast program vector generating module 20. FIG. 12 is a view showing a specific example of a preference vector and broadcast program vectors. In FIG. 12, the broadcast program vectors are expressed so that category-added terms for specifying programs are arranged in rows while respective programs (program IDs) contained in an electronic program guide are arranged in columns. Although Programs 1 to 7 used as programs contained in the electronic program guide for generation of a relevant term model are used for the sake of simplification of explanation, the programs are practically not limited to the programs used for generation of a relevant term model.

In step S1103, the program similarity calculating module 21 reads a relevant term model from the relevant term model storage module 15.

In step S1104, the program similarity calculating module 21 normalizes the broadcast program vector so that the norm of the broadcast program vector becomes 1. FIG. 13 is a view showing the preference vector shown in FIG. 12 and broadcast program vectors normalized so that the norm of each broadcast program vector becomes 1.

In steps S1105 and S1106, the program similarity calculating module 21 reduces the dimensionalities of the preference vector and the broadcast program vector by using the relevant term model in accordance with the following expressions (5) and (6).

dₖ=Uₖ^{T}d (5)

d′ₖ=Uₖ^{T}d′ (6)

In the expressions (5) and (6), d is the preference vector, d′ is the broadcast program vector, Uₖ^{T} is the relevant term model, dₖ is a reduced preference vector, and d′ₖ is a reduced broadcast program vector.

In step S1107, the program similarity calculating module 21 calculates similarity between the preference vector and the broadcast program vector by using an inner product or a cosine similarity. Then, the similarity calculating process is terminated. FIG. 14 shows an example in which similarity between a preference vector and each broadcast program vector reduced by use of a relevant term model U3 at k=3 is calculated by use of an inner product. In FIG. 14, the inner product of the preference vector and the broadcast program vector of each program dimensionally reduced by use of the relevant term model U3 directing attention to three high-relevance category-added terms “History—History”, “History—Civilization” and “History—Inheritance” is obtained as program similarity. For example, the inner product of the preference vector and the broadcast program vector of Program 1 is calculated to be 0×0+(−0.81)×(−0.76)+0×0≈0.61. The calculated similarity is output to the program recommending module 22. When the program has similarity larger than a predetermined threshold, the program is recommended by the program recommending module 22. When, for example, the threshold is 0.4, Programs 1, 2 and 3 are recommended consequently.

When the vectors shown in FIG. 13 are used, the similarity between the preference vector and the broadcast program vector of Program 2 is calculated as an unrecommendable value of 0. On the contrary, when the vectors dimensionally reduced based on the relevant term model as shown in FIG. 14 are used, that is, when processing is performed as described above, the similarity between the preference vector and the broadcast program vector of Program 2 is calculated as a recommendable value of 0.48. That is, the use of the relevant term model permits the similarity to be calculated in consideration of relevant terms.

It is to be understood that the present invention is not limited to the specific embodiments described above and that the present invention can be embodied with the components modified without departing from the spirit and scope of the present invention. The present invention can be embodied in various forms according to appropriate combinations of the components disclosed in the embodiments described above. For example, some components may be deleted from the configurations described as the embodiments. Further, the components described in different embodiments may be used appropriately in combination.

What is claimed is:

1. A program recommending apparatus comprising:
an electronic program guide receiving module configured to receive an electronic program guide transmitted from a broadcast station;
a category-added term generating module configured to extract category information and program abstracts of programs contained in the electronic program guide, extract program-specific terms from the program abstracts by morphological analysis and combine the category information and the program-specific terms to generate category-added terms;
a history storage module configured to store a history of programs viewed by a user;
a preference vector generating module configured to analyze the history based on the generated category-added terms to generate a preference vector indicating user's preferences for programs;
a broadcast program vector generating module configured to analyze the program abstracts of the programs contained in the electronic program guide based on the category-added terms to generate broadcast program vectors indicating the program abstracts of the programs respectively;
a relevant term model generating module configured to generate a relevant term model for the category-added terms;
a program similarity calculating module configured to calculate similarities between the preference vector and each of the broadcast program vectors based on the generated relevant term model; and
a program recommending module configured to output programs having the calculated similarities satisfying a predetermined condition as recommended programs matching with the user's preferences.

2. The apparatus of claim 1, wherein the category-added term generating module generates each of the category-added terms in such a manner that a product of an appearance frequency of each of program-specific terms contained in the electronic program guide-based program abstracts of programs viewed by the user in a certain predetermined period and a reciprocal of a broadcast frequency of each of programs in which the program-specific term appeared is used as a value for weighting the category-added term.

3. The apparatus of claim 1, wherein the relevant term model generating module generates an index term-program matrix by using category-added terms contained in program information in a certain predetermined period as index terms in latent semantic analysis, and generates the relevant term model by singular value decomposition and dimensional reduction of the index term-program matrix.

4. A program recommending method comprising:
receiving an electronic program guide transmitted from any broadcast station;
extracting category information and program abstracts of programs contained in the received electronic program guide;
extracting program-specific terms from the program abstracts by morphological analysis;
combining the category information and the program-specific terms to thereby generate category-added terms;
storing a history of programs viewed by a user;
analyzing the history based on the generated category-added terms to thereby generate a preference vector indicating user's preferences for programs;
analyzing the program abstracts of the programs contained in the electronic program guide based on the category-added terms to thereby generate broadcast program vectors indicating the program abstracts of the programs respectively;
generating a relevant term model for the category-added terms;
calculating similarities between the preference vector and each of the broadcast program vectors based on the generated relevant term model; and
outputting programs having the calculated similarities satisfying a predetermined condition as recommended programs matching with the user's preferences.

5. The method of claim 4, wherein each of the category-added terms is generated in such a manner that a product of an appearance frequency of each of program-specific terms contained in the electronic program guide-based program abstracts of programs viewed by the user in a certain predetermined period and a reciprocal of a broadcast frequency of each of programs in which the program-specific term appeared is used as a value for weighting the category-added term.

6. The method according to claim 4 further comprising generating an index term-program matrix by using category-added terms contained in program information in a certain predetermined period as index terms in latent semantic analysis,
wherein the relevant term model is generated by singular value decomposition and dimensional reduction of the index term-program matrix.
